(19) United States
(12) Patent Application Publication
(10) Pub. No.: US 2024/0272918 A1
(43) Pub. Date: Aug. 15, 2024

(54) ROBOTIC PROCESS AUTOMATION PROVIDING PROCESS IDENTIFICATION FROM RECORDINGS OF USER-INITIATED EVENTS

(71) Applicant: Automation Anywhere, Inc., San Jose, CA (US)

(72) Inventors: Peter Ryan Magnuson, Boston, MA (US); Matthew Thomas Wright, Aptos, CA (US)

(73) Assignee: Automation Anywhere, Inc., San Jose, CA (US)

(21) Appl. No.: 18/401,085

(22) Filed: Dec. 29, 2023

Related U.S. Application Data
(60) Provisional application No. 63/442,455, filed on Jan. 31, 2023.

(51) Int. Cl. G06F 9/451; G06F 3/0484

(52) U.S. Cl. CPC G06F 9/451; G06F 3/0484

(57) ABSTRACT

Systems and methods for locating repeatable user-driven processes in recordings of users interacting with application programs. The processing, such as by a Robotic Process Automation (RPA) system, to locate repeatable user-driven processes can, for example, initially acquire various recordings of one or more users interacting with one or more application programs operating on one or more user devices. The recordings can include at least user-triggered events as well as a User Interface (UI) screen image captured for each of the user-triggered events. By processing the captured UI screens from the recordings, those of the screen images that are more likely (or predictably) used to start or stop a repeatable user-driven process can be selected. Thereafter, repeatable user-driven processes within the recordings can be identified based on the selected screen images. Advantageously, the repeatable user-driven processes found within the recordings can thereafter be converted into software robots.

### CROSS-REFERENCE TO RELATED APPLICATION

This application claims priority to U.S. Provisional Patent Application No. 63/442,455, filed Jan. 31, 2023, and entitled “ROBOTIC PROCESS AUTOMATION PROVIDING PROCESS IDENTIFICATION FROM RECORDINGS OF USER-INITIATED EVENTS,” which is hereby incorporated by reference herein.

### BACKGROUND OF THE INVENTION

Robotic process automation (RPA) systems enable automation of repetitive and manually intensive computer-based tasks. In an RPA system, computer software, namely a software robot (often referred to as a “bot”), may mimic the actions of a person in order to perform various computer-based tasks. For instance, an RPA system can interact with one or more software applications through user interfaces, as a person would do. Therefore, RPA systems typically do not need to be integrated with existing software applications at a programming level, thereby eliminating the difficulties inherent to integration. Advantageously, RPA systems permit automation of application-level repetitive tasks via software robots that are coded to repeatedly and accurately perform the repetitive tasks.

To assist with the creation of useful software robots, RPA systems can seek to identify processes that can be automated. Conventionally, discovery of processes to automate is challenging because user-initiated processes vary widely. Therefore, there is a need for improved approaches to identify repeatable user-initiated processes that can be automated by software robots.

### SUMMARY

Systems and methods for locating repeatable user-driven processes in recordings of users interacting with application programs operating on user devices are disclosed. The processing to locate repeatable user-driven processes can, for example, initially acquire various recordings of one or more users interacting with one or more application programs operating on one or more user devices. The recordings can include at least user-triggered events as well as a User Interface (UI) screen image captured for each of at least a plurality of the user-triggered events. The captured UI screen for each of at least a plurality of the user-triggered events can then be processed to identify UI controls and metadata therefor. Next, the identified UI controls that the one or more users interacted with can be determined, and then the determined UI controls that are more likely (or predictably) used to start or stop a repeatable user-driven process can be identified. Those of the UI screen images from the recordings that utilize the determined UI controls can then be identified. Next, a subset of the identified screen images that are more likely (or predictably) used to start or stop a repeatable user-driven process can be selected from the identified set of the UI screen images. Thereafter, repeatable user-driven processes within the recordings can be identified based on the subset of the identified screen images. Advantageously, the repeatable user-driven processes found within the recordings can thereafter be converted into software robots. These systems and methods for locating user-driven processes can be suitable for use in an RPA system.

The invention can be implemented in numerous ways, including as a method, system, device, apparatus (including computer readable medium and graphical user interface). Several embodiments of the invention are discussed below.

As a computer-implemented method for locating repeatable user-driven processes, one embodiment can, for example, include at least: acquiring recordings of at least one user interacting with at least one application program operating on at least one user computing device, the recordings including at least user-triggered events, and a user interface (UI) screen image captured for each of at least a plurality of the user-triggered events; acquiring UI controls and metadata from the captured UI screen images; identifying, from the acquired UI controls, a set of selected UI controls that a user selected during the recordings; obtaining, from the set of selected UI controls, a subset of UI controls that are known to indicate a start or stop of repeatable user-driven processes; and selecting a set of candidate UI screen images from the captured UI screen images based on the subset of UI controls that are known to indicate a start or stop of repeatable user-driven processes.

As a computer-implemented method for locating repeatable user-driven processes for conversion into software robots, one embodiment can, for example, include at least: acquiring recordings of a plurality of users interacting with at least application programs operating on user computing devices, the recordings including at least user-triggered events with corresponding user interface (UI) screen images captured for the user-triggered events; acquiring UI controls and metadata from the UI screen images within the recordings; identifying, from the acquired UI controls, a set of selected UI controls that a user selected during the recordings; obtaining a set of UI controls that are known to indicate a start or stop of repeatable user-driven processes; and selecting a set of candidate UI screen images from the UI screen images within the recordings based on those of the set of selected UI controls that a user selected during the recordings which are within the set of UI controls that are known to indicate a start or stop of repeatable user-driven processes.

As a non-transitory computer readable medium including at least computer program code tangible stored therein for locating repeatable user-driven processes, one embodiment can, for example, include at least: computer program code for acquiring recordings of a plurality of users interacting with at least application programs operating on their respective user computing devices, the recordings including at least user-triggered events, and a user interface (UI) screen image captured for each of at least a plurality of the user-triggered events; computer program code for acquiring UI controls and metadata from the captured UI screen images; computer program code for identifying, from the acquired UI controls, a set of selected UI controls that a user selected during the recordings; computer program code for obtaining, from the set of selected UI controls, a subset of UI controls that are known to indicate a start or stop of repeatable user-driven processes; and computer program code for selecting a set of candidate UI screen images from the captured UI screen images based on the subset of UI controls that are known to indicate a start or stop of repeatable user-driven processes.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of a programmatic automation environment according to one embodiment.

FIG. 2 is a diagram of a software robot creation process according to one embodiment.

FIG. 3 is a block diagram of a pre-processing subsystem according to one embodiment.

FIG. 4 is a block diagram of a process identification system according to one embodiment.

FIG. 5 is a block diagram of a process identification system according to another embodiment.

FIG. 6 is a flow diagram of a process identification method according to one embodiment.

FIG. 7A is a flow diagram of a process identification method according to another embodiment.

FIG. 7B is a flow diagram of a process identification method according to still another embodiment.

FIG. 8 is a block diagram of a robotic process automation system according to one embodiment.

FIG. 9 is a block diagram of a generalized runtime environment for bots in accordance with another embodiment of the robotic process automation system illustrated in FIG. 8.

FIG. 10 is yet another embodiment of the robotic process automation system of FIG. 8 configured to provide platform independent sets of task processing instructions for bots.

FIG. 11 is a block diagram illustrating details of one embodiment of the bot compiler illustrated in FIG. 10.

FIG. 12 is a block diagram of an exemplary computing environment for an implementation of a robotic process automation system.

### DETAILED DESCRIPTION OF CERTAIN EMBODIMENTS

Systems and methods for locating repeatable user-driven processes in recordings of users interacting with application programs operating on user devices (i.e., user computing devices) are disclosed. The processing to locate repeatable user-driven processes can, for example, initially acquire various recordings of one or more users interacting with one or more application programs operating on one or more user devices. The recordings can include at least user-triggered events as well as a User Interface (UI) screen image captured for each of at least a plurality of the user-triggered events. The captured UI screen for each of at least a plurality of the user-triggered events can then be processed to identify UI controls and metadata therefor. Next, the identified UI controls that the one or more users interacted with can be determined, and then the determined UI controls that are more likely (or predictably) used to start or stop a repeatable user-driven process can be identified. Those of the UI screen images from the recordings that utilize the determined UI controls can then be identified. Next, a subset of the identified screen images that are more likely (or predictably) used to start or stop a repeatable user-driven process can be selected from the identified set of the UI screen images. Thereafter, repeatable user-driven processes within the recordings can be identified based on the subset of the identified screen images. Advantageously, the repeatable user-driven processes found within the recordings can thereafter be converted into software robots. These systems and methods for locating user-driven processes can be suitable for use in an RPA system.

Generally speaking, RPA systems use computer software to emulate and integrate the actions of a person interacting within digital systems. In an enterprise environment, the RPA systems are often designed to execute a business process. In some cases, the RPA systems use artificial intelligence (AI) and/or other machine learning capabilities to handle high-volume, repeatable tasks that previously required humans to perform. The RPA systems also provide for creation, configuration, management, execution, and/or monitoring of software automation processes.

A software automation process can also be referred to as a software robot, software agent, or a bot. A software automation process can interpret and execute tasks on one's behalf. Software automation processes are particularly well suited for handling repetitive tasks that people perform every day. Software automation processes can accurately perform a task or workflow they are tasked with over and over. As one example, a software automation process can locate and read data in a document, email, file, or window. As another example, a software automation process can connect with one or more Enterprise Resource Planning (ERP), Customer Relations Management (CRM), core banking, and other business systems to distribute data where it needs to be in whatever format is necessary. As another example, a software automation process can perform data tasks, such as reformatting, extracting, balancing, error checking, moving, copying, or any other desired tasks. As another example, a software automation process can grab data desired from a webpage, application, screen, file, or other data source. As still another example, a software automation process can be triggered based on time or an event, and can serve to take files or data sets and move them to another location, whether it is to a customer, vendor, application, department or storage. These various capabilities can also be used in any combination.

As an example of an integrated software automation process making use of various capabilities, the software automation process could start a task or workflow based on a trigger, such as a file being uploaded to an FTP system. The integrated software automation process could then download that file, scrape relevant data from it, upload the relevant data to a database, and then send an email to a recipient to inform the recipient that the data has been successfully processed.

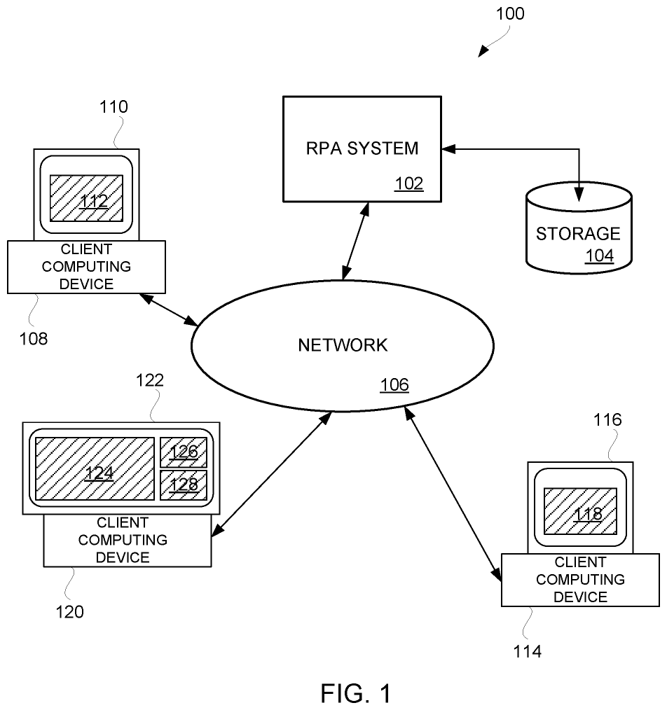

Embodiments of various aspects of the invention are discussed below with reference to FIGS. 1-12. However, those skilled in the art will readily appreciate that the detailed description given herein with respect to these figures is for explanatory purposes as the invention extends beyond these limited embodiments.

FIG. 1 is a block diagram of a programmatic automation environment 100 according to one embodiment. The programmatic automation environment 100 is a computing environment that supports RPA. The computing environment can include or make use of one or more computing devices. Each of the computing devices can, for example, be an electronic device having computing capabilities, such as a mobile phone (e.g., smart phone), tablet computer, desktop computer, portable computer, server computer, and the like.

The programmatic automation environment 100 serves to support recordation of a series of user interactions of a user with one or more software programs operating on a computing device. The recordation of the series of user interactions forms a recoding. By obtaining a significant number of recordings over time, the programmatic automation environment can then discover potential user processes from the recordings that can be automated. For example, the recordings can designate user-initiated events and include captured screen images that correspond to the user-initiated events. By extracting UI controls and metadata from the captured screen images and then examining the UI controls that a user has interacted with, a set of UI controls that are known to indicate a start and stop of a repeatable user-driven process can be identified. Then, a set of candidate UI screen images from the captured UI screens can be selected to signal the start and stop of the repeatable user-driven process. From there, if desired, a software automation process (e.g., software robot) can be created to carry out a discovered user-driven process. Execution of the software automation process can thereafter perform the discovered user-initiated process in an automated manner with the same one or more software programs operating on the same or different computing device.

The programmatic automation environment 100 includes an RPA system 102 that provides the robotic process automation. The RPA system 102 supports a plurality of different robotic processes, which can be denoted as software automation processes. These software automation processes can also be referred to as “software robots,” “bots” or “software bots.” The RPA system 102 can create, maintain, execute, and/or monitor software automation processes. The RPA system 102 can also store software automation processes in storage 104. The RPA system 102 can also report status or results of software automation processes.

The programmatic automation environment 100 can support various different types of computing devices that can interact with the RPA system 102. The programmatic automation environment 100 can include a network 106 made up of one or more wired or wireless networks that serve to electronically interconnect various computing devices for data transfer. These computing devices can serve as a recording computing device, a playback computing device, or both. As shown in FIG. 1, the programmatic automation environment 100 can include a recording computing device 108 that includes a display device 110 and a window 112 presented on the display device 110. The window 112 can, in one example, depict a user interface that is associated with recording user interactions with one or more application programs to produce a software automation process using the RPA system 102.

The programmatic automation environment 100 shown in FIG. 1 can also include various playback computing devices that can execute software automation processes. A first playback computing device 114 includes a display device 116 that can present a window 118. A second playback computing device 120 includes a display device 122 that can present a first window 124, a second window 126 and a third window 128. More generally, the windows are screens that are presented and visible on respective display devices. Of course, the recording computing device 108 can also operate as a playback computing device and the playback computing devices 114 and 120 can also operate as recoding computing devices.

The RPA system 102 supports creation and storage of software automation processes. These software automation processes can be referred to as “bots”. In the simplified block diagram shown in FIG. 1, the RPA system 102 can support a recording session in which a series of user interactions with one or more application programs operating on a computing device, such as the recording computing device 108, can be recorded. The series of user interactions can then be utilized by the RPA system 102 to discover repeatable user-initiated processes and to form software automation processes (e.g., bots) for carrying out such processes in an automated manner. The RPA utilization environment 100 can also store, such as in the store 104, the software automation processes (e.g., bots) that have been created.

In addition, the RPA system 102 further supports the execution of the one or more software automation processes that have been created by the RPA system 102 or some other RPA system. Execution (or running) of a software automation process at a computing device, such as the playback computing device 114 or the playback computing device 120, causes the software automation process to perform its underlying process. The underlying process, when performed by the software automation process, can perform (via automation) one or more tasks on behalf of a user.

On execution of one or more software automation processes, the previously established software automation processes via the RPA system 102, can interact with one or more software programs. One example of the software program is an application program. Application programs can vary widely with user's computer system and tasks to be performed thereon. For example, application programs being used might be word processing programs, spreadsheet programs, email programs, ERP programs, CRM programs, web browser programs, any many more. The software program 106, when operating, typically interacts with one or more windows. For example, a user interface presented within the one or more windows can be programmatically interacted with through execution of the one or more software automation processes.

In some cases, the software program is seeking to access documents that contain data that is to be extracted and then suitably processed. The documents are typically digital images of documents, which are presented in the one or more windows. The RPA system 102 can include or support processing and structures to support the extraction of data from such document images. Some examples of documents include emails, web pages, forms, invoices, purchase orders, delivery receipts, bill of lading, insurance claims forms, loan application forms, tax forms, payroll reports, etc.

In one embodiment, a process can be discovered within a recording by forming a list of all UI screens that a user visited during a recording. Each UI screen can be given a screen signature, so that like UI screens can be considered the same. The list of UI screens can then be ranked. For example, the UI screens within the list of UI screens can be ranked with respect to how likely a particular UI screen is associated with a user's inputs that trigger either a starting or stopping of a particular process, e.g., a business process. The higher ranked UI screens are then available for use in discovering repeatable user-driven process that are suitable for automation. In one implementation, the ranking can use a frequency-based ranking scheme. As an example, the frequency-based ranking can (i) determine the number of times a particular UI screen appears in a recording; (ii) then out of the number of times the particular UI screen appears, use an event log and/or metadata of the recording to determine how many times the user interacted with a known or ranked start or stop UI control within that particular screen; and (iii) thereafter, for each time the particular UI screen appears in the recording and the user interacted with a known or ranked start or stop UI control, increase a ranking value for the particular UI screen by a determined amount.

Those UI controls that are known to indicate a start and stop UI controls of a repeatable user-driven process can be utilized to select or rank the identified UI controls. For example, those UI controls that are known to indicate a start and stop UI controls of a repeatable user-driven process can be ranked with respect to how likely each UI control is associated with a user's inputs that trigger either a starting or stopping of a particular process. Although these known UI controls that are known to indicate a start or stop UI controls of repeatable user-driven processes can be empirically determined over time, they can also be determined though use of artificial intelligence and machine learning.

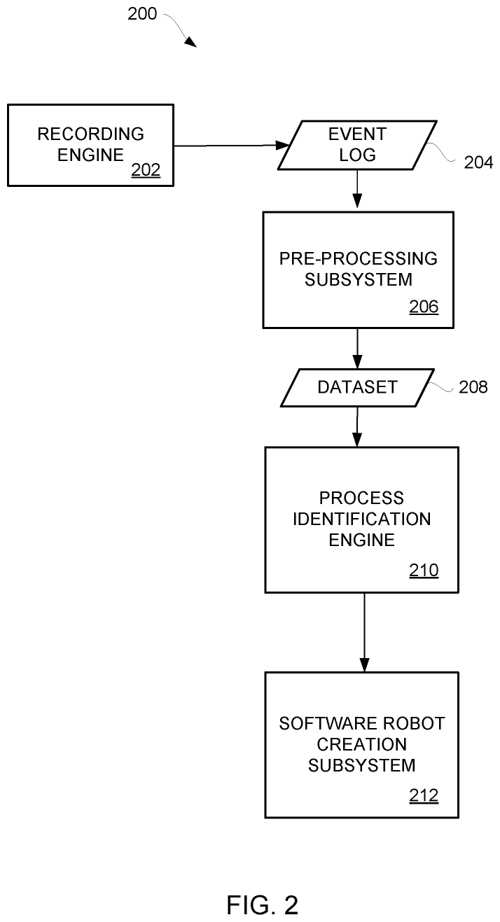

FIG. 2 is a diagram of a software robot creation process 200 according to one embodiment. The software robot creation system 200 can, in general, evaluate user interactions with their computing devices occurring over a period of time to discover repeatable user-driven processes that may be suitable for creation of software robots which could be then used to carry out the user-driven processes in an automated fashion.

The software robot creation system 200 receives a plurality of recordings from a recording engine 202. The recordings include logs of user interactions with their computing devices and various software programs operating thereon. The recordings can pertain to one user or multiple users. For example, the recordings can capture user-initiated events with respect to the software applications operating on user's computing devices. The recordings can also capture user interface screens that correspond to the user-initiated events. Typically, the recordings would be captured over an extended period of time, such as several days, one or more weeks or one or more months, so that the recordings provide a meaningful data set for discovery of repeatable processed being carried out by users. Accordingly, the recordings from the recording engine can provide an event log 204 that details the user-initiated events that have taken place with respect to one or more software applications over a period of time.

The event log 204 can then be provided to a pre-processing subsystem 206. The pre-processing subsystem 206 can perform pre-processing operations with respect to the event log 204. In doing so, the event log 204 can be augmented to include additional metadata concerning the user-initiated events identified in the event log 204. The additional metadata acquired by the pre-processing system 206 can include information extracted from the event log 204 of the recordings concerning user interface objects and their properties found within the user interface screens that correspond to the user-initiated events. As an example, the pre-processing operations provided by the pre-processing system 206 can include (i) detecting UI controls within images of the user interface screens from the recordings; (ii) Optical Character Recognition (OCR) processing to recognize text within images of the user interface screens from the recordings; (iii) associating text strings from the recognized text to corresponding ones of a plurality of the corresponding UI controls; and/or (iv) using artificial intelligence systems for identifying objects, text, and/or other parameters within images captured with the recordings. The event log 204, after being augmented by the pre-processing subsystem 206, can be referred to as a dataset 208.

The software robot creation system 200 can also include a process identification engine 210. The process identification engine 210 can examine the dataset 208 to locate potential user-driven processes that may be suitable for automation by a software robot. In doing so, the process identification engine 210 can locate a starting point and stopping point for one or more repeatable, user-driven processes. In one implementation, the process identification engine 210 provides potential candidates for starting points and ending points for the one or more repeatable, user-driven processes.

After the process identification engine 210 has identified the potential user-driven processes within the dataset 208, the potential candidates can be provided to a software robot creation subsystem 212. The software robot creation subsystem 212 can then determine whether or which one or more of the potential candidates for starting and ending points for the one or more repeatable user-driven processes should be selected and used to create, or recommend creation, of a software robot.

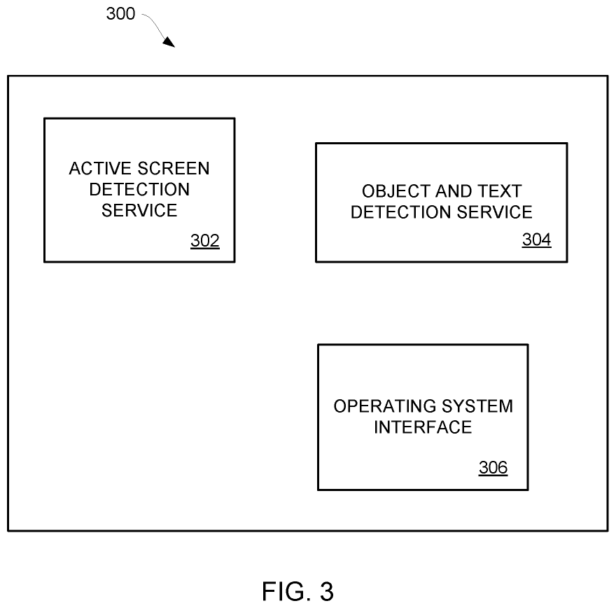

FIG. 3 is a block diagram of a pre-processing subsystem 300 according to one embodiment. The pre-processing subsystem 300 is, for example, suitable for one implementation of the pre-processing subsystem 206 illustrated in FIG. 2.

The pre-processing subsystem 300 can include an active screen detection service 302, an object and text detection service 304, and an operating system interface 306. The pre-processing subsystem 300 is generally utilized to acquire metadata concerning user-initiated events associated with recordings. The metadata, for example, can include data extracted from user interface screens there are associated with the user-initiated events. The active screen detection service 302 can determine which user interface screen is active when a user-initiated event occurs. The active screen detection service 302 can utilize data from the operating system interface 306 to determine where on the particular user interface screen a user made a selection that correlates to the user-initiated event. For example, the operating system interface 306 can provide mouse or pointer coordinates.

The object and text detection service 304 can evaluate the active user interface screen to extract object and text information therefrom. Objects can, for example, be graphical user interface (GUI) components within each screen image, such as buttons, radio buttons, scroll bars, text entry fields, etc. Of particular interest is the object to which the user-initiated event corresponds. The object and text detection service 304 can also interact with the operating system interface 306 to determine which object (e.g., user interface control) the user interacted with to initiate the user-initiated event. The object and text detection service 304 can also determine properties for the determined object, including any detected text that is present within the user interface screen that is associated with the determined object. The text detection from an image of the user interface screen can be performed by Optical Character Recognition (OCR) processing.

Additional details on detection of controls from images according to some embodiments are provided in (i) U.S. patent application Ser. No. 16/527,048, filed Jul. 31, 2019, and entitled “AUTOMATED DETECTION OF CONTROLS IN COMPUTER APPLICATIONS WITH REGION BASED DETECTORS,” which is hereby incorporated by reference herein by reference; and (ii) U.S. patent application Ser. No. 16/876,530, filed May 18, 2020, and entitled “DETECTION OF USER INTERFACE CONTROLS VIA INVARIANCE GUIDED SUB-CONTROL LEARNING,” which is hereby incorporated herein by reference for all purposes.

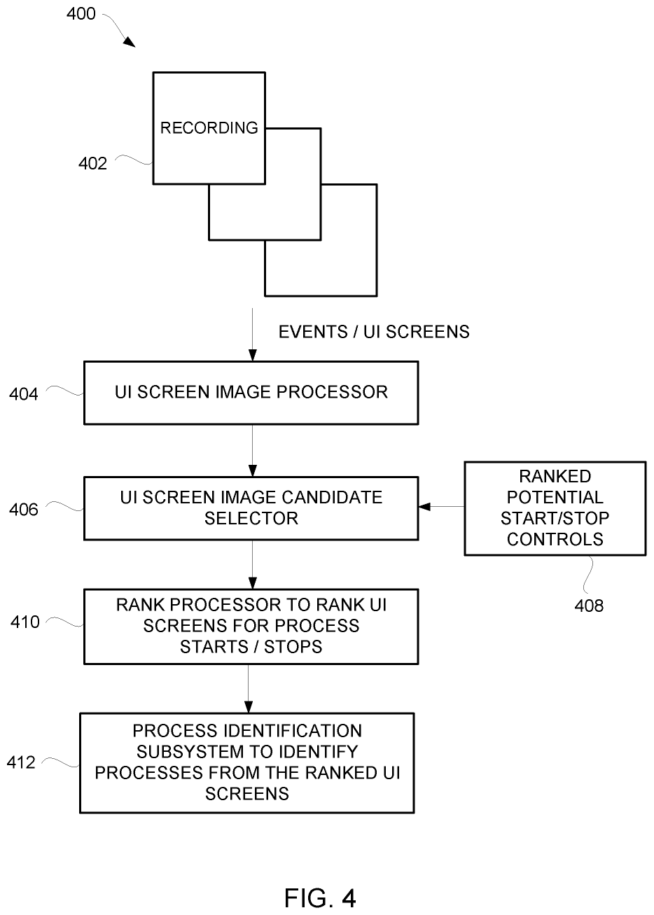

FIG. 4 is a block diagram of a process identification system 400 according to one embodiment. The process identification system 400 is, for example, suitable for use as the process identification engine 210 illustrated in FIG. 2.

The process identification system 400 can receive a plurality of recordings 402. The recordings 402 are recordings of user interactions with one or more software applications operating on one or more computing devices. The recordings 402 can include user-initiated events (e.g., interactions with software applications, initiated by a user, to perform various tasks) as well as user interface (UI) screens associated with the user-initiated events. The user-initiated events and UI screens provided by the recordings 402 can be provided to a UI screen image processor 404. The UI image screen processor 404 processes the images of the UI screens associated with the user-initiated events provided by the recordings 402 to identify UI controls and properties thereof.

The process identification system 400 can also include a UI screen image candidate selector 406. The UI screen image candidate selector 406 can receive ranked potential start/stop controls 408. The rank potential start/stop controls 408 can be UI controls that have been previously been determined to represent UI controls that users typically select or interact with to either start or stop various tasks. The UI screen image candidate selector 406 can also receive the UI controls and associated properties from the UI image screen processor 404 that have been extracted from the UI screens provided by the recordings 402.

The UI screen image candidate selector 406 can then select a subset of the UI screens provided by the recordings 402. The subset of the UI screens can be selected based on those of the extracted UI controls provided by the recordings 402 that match higher ranked potential start/stop controls 408 from the rank potential start/stop controls 408. The subset of UI screens selected by the UI screen image candidate selector 406 can be provided to a rank processor 410. The rank processor 410 can operate to rank the selected UI screens within the subset of UI screens for process starts and/or stops, such as for example according to the likelihood that the various UI screens correspond to the starts and/or stops of processes. Typically, the rank processor 410 operates to separately rank start UI screens and stop UI screens. The ranking can be a heuristic-based ranking.

One implementation of a ranking is a ranking based on frequency of occurrence. For example, those selected UI screens which appear more frequently in the recording 402 and which have at least one of the higher ranked potential start/stop controls 408 can be ranked higher.

Another implementation of a ranking is that those selected UI screens on which a user interacts that have a UI control that is ranked higher, will cause those selected UI screens to be ranked higher. For example, suppose that a user visits a first UI screen fifty (50) times in a given recording, and the event log or derived metadata indicates that the user clicked on a “Start” UI control a total of forty (40) times (and where the “Start” UI control is a UI control that is known (or predictably known) to start a user process), then this first UI screen could be given a ranking of forty (40). On the other hand, suppose that a user visits a second UI screen one-hundred times (100) times in a given recording, and the event log or derived metadata indicates that the user clicked on a “Start” control a total of forty (10) times (and where the “Start” UI control is a UI control that is known (or predictably known) to start a user process), then this second UI screen could be given a ranking of ten (10). Hence, in this example, the first UI screen would be ranked higher that the second UI screen. As a result, the first UI screen is a more likely used UI screen for a start of a user-initiated process.

Still another implementation of a ranking is that those selected UI screens on which a user interacts with UI controls that are higher ranked controls can cause such selected UI screens to be ranked higher. In other words, UI screens can be ranked where ranking is increased according weighted values assigned to each of the_UI controls. So when users interact with higher ranked UI controls, the ranking of the selected UI screens will increase in view of the higher ranked UI controls being interacted with.

Still another embodiment of a ranking is that specific UI screens known, such as though empirical evaluation, to denote starts or stops of repeatable user-initiated processes can be highly ranked start or stop UI screens. At the same time, specific UI screens may be ranked lower if they are known to be less likely to correspond to the starts or stops of processes.

It should be understood that various other methods can also be used to rank UI screens where the following various factors, and combinations thereof, can be taken into account: specific UI controls that appear in UI screens, the number of times users interact with specific UI controls, the ranking of specific UI controls, the number of times UI screens appear in recordings, and human designated rankings. Note that this list of factors is non-limiting and other factors may also be used.

Note that UI screens can be identified by a UI screen signature. Two screens having the same (or substantially similar) UI screen signature are deemed the same UI screen. Additional details on screen signature can be found in U.S. patent application Ser. No. 18/103,331, filed Jan. 30, 2023, and entitled “IDENTIFYING USER INTERFACES OF AN APPLICATION,” which is hereby incorporated herein by reference.

After the rank processor 410 has ranked the UI screens for process starts and stops, a process identification subsystem 412 can seek to identify processes from the ranked UI screens. In this regard, a process can be identified as having a start UI screen and a stop UI screen. The start UI screen can be selected from the highly ranked UI screens for starts, and the stop UI screen can be selected from the highly ranked UI screens for stops (or ends).

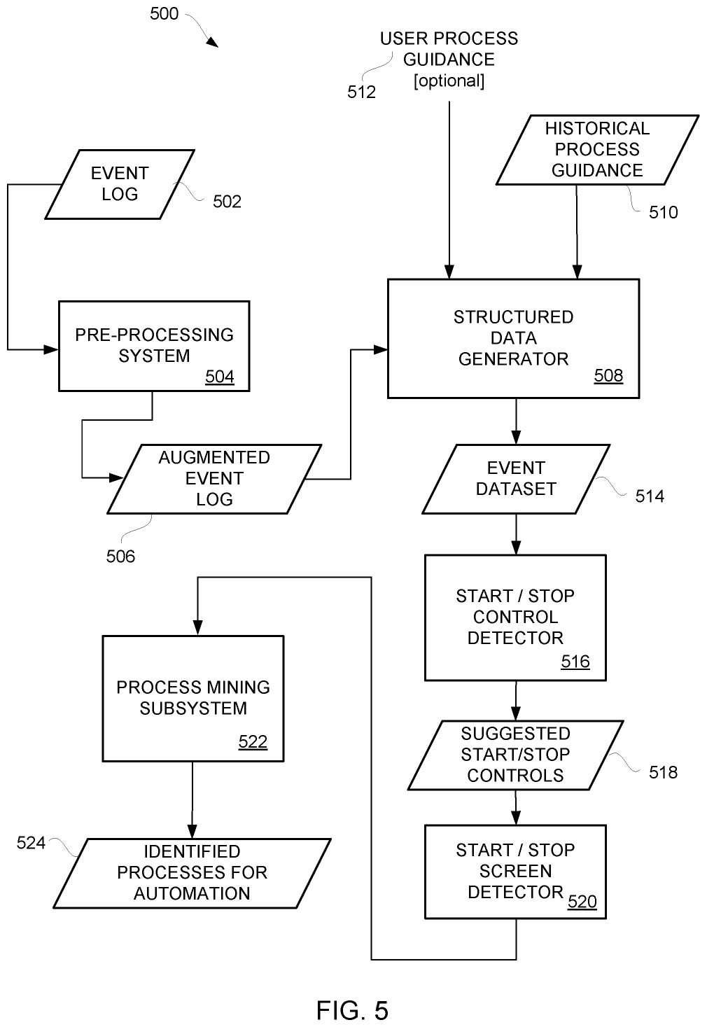

FIG. 5 is a block diagram of a process identification system 500 according to another embodiment. The process identification system 500 is, for example, suitable for use as the process identification engine 210 illustrated in FIG. 2.

The process identification system 500 can receive an event log 502. The event log 502 includes event information pertaining to a plurality of different recordings. The plurality of different recordings can be associated with one or more users. A pre-processing subsystem 504 receives the event log 502 and produces an augmented event log 506. The augmented event log 506 is also referred to as a dataset such as the dataset 208 illustrated in FIG. 2. The augmented event log 506 contains additional metadata which is obtained by processing user interface images contained within the event log 502. The additional metadata can, for example, include user interface controls and associated properties for user interface screens that are included within (or associated with) the event log 502

A structured data generator 508 can receive the augmented event log 506, historical process guidance 510, and optionally user process guidance 512. The structured data generator 508 can examine the augmented event log 506 in view of the historical process guidance 502 to identify user interface objects (e.g., user interface controls) that more likely are used when a process is started or ended. Additionally, optionally, the user process guidance 512 might be utilized to signal typical user interface objects used that a given user (or type of user) uses to start and end a process. The structured data generator 508 produces an event dataset 514. The event dataset 514 is a structured dataset includes at least user interface screens with corresponding user interface objects and metadata.

A start/stop control detector 516 can then evaluate the event dataset 514 to determine which of the user interface objects within the event dataset 514 are to be selected as suggested start/stop controls 518 for user-initiated processes found within the recordings contained within the event log 502.

A start/stop screen detector 520 can then determine suggested start/stop user interface screens from the user interface screens within the recording that include the suggested start/stop controls 518. A process mining subsystem 522 can then further examine the suggested start/stop user interface screens to identify processes 524. The identified processes can then be candidates for automation.

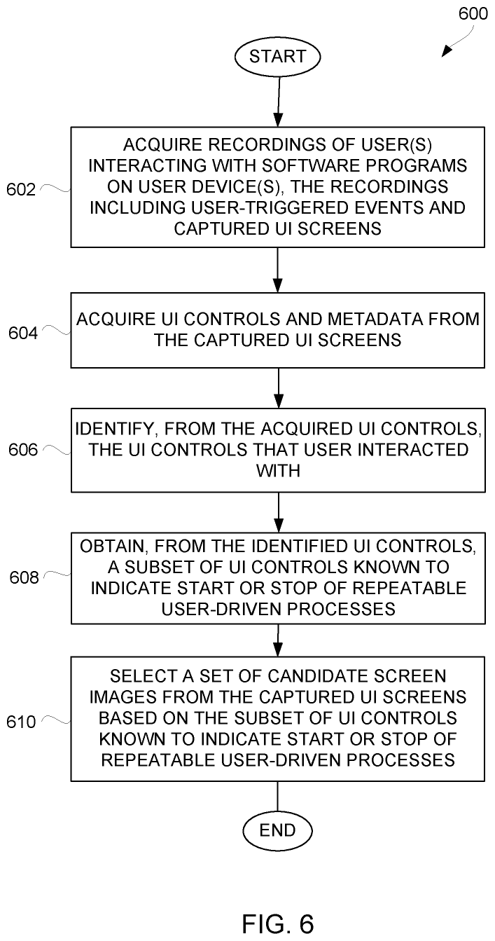

FIG. 6 is a flow diagram of a process identification method 600 according to one embodiment. The process identification method 600 is, for example, processing carried out by the process identification engine 210 illustrated in FIG. 2.

The process identification method 600 can acquire 602 recordings of one or more users interacting with one or more software programs on one or more user devices. The recordings being acquired 602 can include user-triggered events and captured UI screens. The captured UI screens are screen images from user interfaces of software programs (e.g., application programs) that the user has interacted with while inducing the user-triggered events. Next, UI controls and metadata can be acquired 604 from the captured UI screens. In one implementation, the metadata can include data pertaining to properties of the UI controls. The acquisition 604 of the UI controls and metadata can result from object detection and optical character recognition from the captured UI screens.

Next, the UI controls that the user interacted with can be identified 606 from the acquired UI controls. That is, in causing the user-triggered events, the user interacts with a user interface provided by a software program. The UI screen being presented by the user interface is captured as the capture UI screen. From the captured UI screen, processing can be performed to identify 606 the particular UI controls that the user interacted with at the time of the corresponding user-triggered events. Then, a subset of UI controls known to indicate start or stop of repeatable user-driven processes can be obtained 608 from the identified UI controls. Here, the subset of UI controls being obtained 608 are those of the identified UI controls that the user has interacted with that are also UI controls known to indicate a start or stop of repeatable user-driven processes. Finally, a set of candidate screen images from the captured UI screens can be selected 610 based on the subset of UI controls known to indicate a start or stop of repeatable user-driven processes.

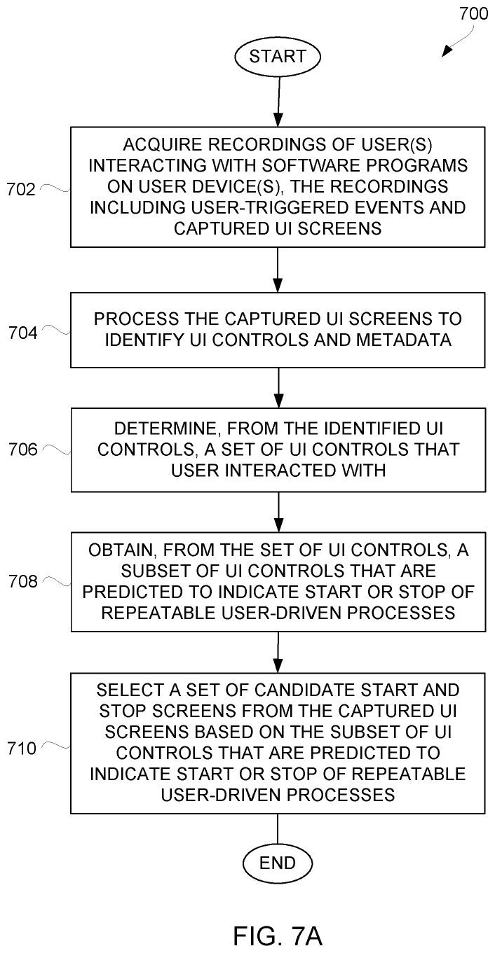

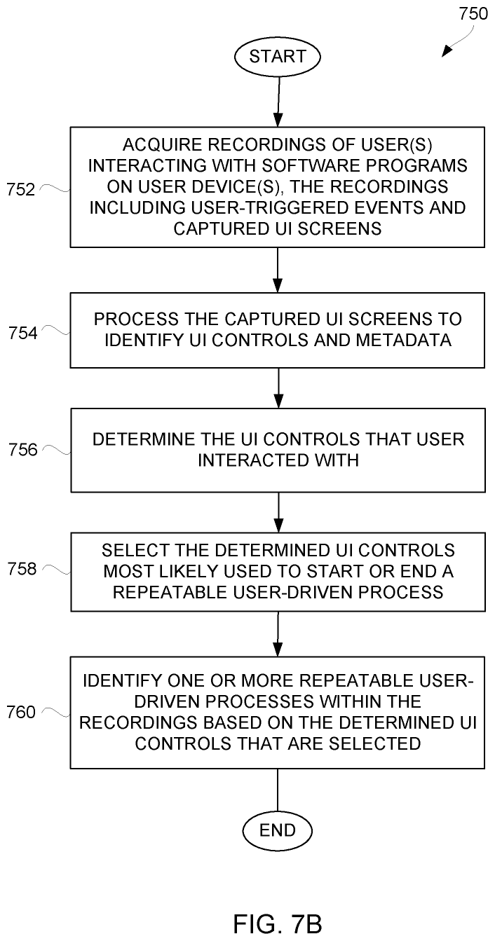

FIG. 7A is a flow diagram of a process identification method 700 according to another embodiment. The process identification method 700 is, for example, processing carried out by the process identification engine 210 illustrated in FIG. 2.

The process identification method 700 can acquire 702 recordings of one or more users interacting with one or more software programs on one or more user devices. The recordings being acquired 702 can include user-triggered events and captured UI screens. The captured UI screens are screen images from user interfaces of software programs (e.g., application programs) that the user has interacted with while inducing the user-triggered events. Next, the captured UI screens can be processed 704 to identify UI controls and metadata from the captured UI screens. In one implementation, the metadata can include data pertaining to properties of the UI controls. The processing 704 to identify the UI controls and metadata can result from object detection and optical character recognition from the captured UI screens.

Next, the process identification method 700 can determine 706, from the identified UI controls, a set of the UI controls that the user interacted with. The UI controls that the user interacted with are those user interface controls on the captured UI screen that the user interacted with when inducing the corresponding user-triggered event. A subset of UI controls that are predicted to indicate start or stop UI controls of repeatable user-driven processes can be obtained 708 from the set of UI controls. For example, only some of the set of UI controls that the user interacted with are known to be predictable of start or stop UI controls of a repeatable user-driven process. Hence, it is the subset of UI controls that are predicted to indicate start or stop of the repeatable user-driven process that are obtained 708. Finally, a set of candidate start and stop screens can be selected 710 from the captured UI screens based on the subset of UI controls that are predicted to indicate start or stop of repeatable user-driven processes.

FIG. 7B is a flow diagram of a process identification method 750 according to still another embodiment. The process identification method 750 is, for example, processing carried out by the process identification engine 210 illustrated in FIG. 2.

The process identification method 750 can initially acquire 752 recordings of users interacting with software programs (e.g., application programs) on user devices. The recordings can include user-triggered events and captured UI screens associated with those user-initiated events.

After the recordings are acquired 752, the captured UI screens can be processed 754 to identify UI controls and metadata within the capture UI screens. In addition, the UI controls that the user interacted with can be determined 756. In one implementation, the metadata can include data pertaining to properties of the UI controls. The processing to determine 756 the UI controls and metadata can result from object detection and optical character recognition from the captured UI screens.

Next, the UI controls that the user interacted with can be determined 756. The operating system for the user's computing device on which the captured UI screen was obtained can also provide a pointer (e.g., cursor) position when the associated user-triggered event occurred. This pointer position information can be considered part of the metadata. The UI controls that the user interacted with can be determined 756 based on the metadata, including the pointer position information.

Thereafter, the determined UI controls that are more likely to be used to start or stop a repeatable user-driven process can be selected 758. The determined UI controls that are selected 758 can result from a ranking of the determined UI controls. For example, those of the determined UI controls that are known to signal a start or end of a process can be ranked according to their frequency of occurrence within the acquired recordings. In one implementation, the UI controls can be separately ranked for signaling a start of a user-initiated process or for signaling an end of the user-initiated process.

Finally, the process identification method 750 can identify 760 one or more repeatable user-driven processes within the recordings based on the determined UI controls that are selected 758. The process identification method 750 can then end. However, if desired, after the identification 760 of the one or more repeatable user-driven processes, additional processing can be performed to produce one or more software robots to respectively carry out the identified one or more repeatable user-driven processes.

The various aspects disclosed herein can be utilized with or by robotic process automation systems. Exemplary robotic process automation systems and operations thereof are detailed below.

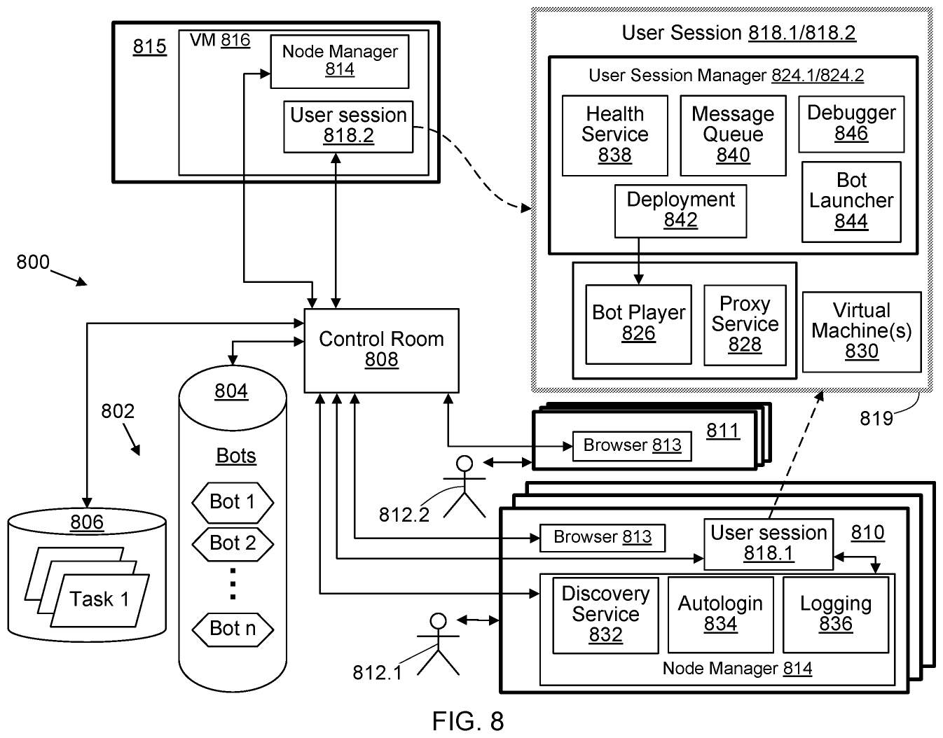

FIG. 8 is a block diagram of a robotic process automation (RPA) system 800 according to one embodiment. The RPA system 800 includes data storage 802. The data storage 802 can store a plurality of software robots 804, also referred to as bots (e.g., Bot 1, Bot 2, . . . , Bot n). The software robots 804 can be operable to interact at a user level with one or more user level application programs (not shown). As used herein, the term “bot” is generally synonymous with the term software robot. In certain contexts, as will be apparent to those skilled in the art in view of the present disclosure, the term “bot runner” refers to a device (virtual or physical), having the necessary software capability (such as bot player 826), on which a bot will execute or is executing. The data storage 802 can also stores a plurality of work items 806. Each work item 806 can pertain to processing executed by one or more of the software robots 804.

The RPA system 800 can also include a control room 808. The control room 808 is operatively coupled to the data storage 802 and is configured to execute instructions that, when executed, cause the RPA system 800 to respond to a request from a client device 810 that is issued by a user 812.1. The control room 808 can act as a server to provide to the client device 810 the capability to perform an automation task to process a work item from the plurality of work items 806. The RPA system 800 is able to support multiple client devices 810 concurrently, each of which will have one or more corresponding user session(s) 818, which provides a context. The context can, for example, include security, permissions, audit trails, etc. to define the permissions and roles for bots operating under the user session 818. For example, a bot executing under a user session, cannot access any files or use any applications that the user, under whose credentials the bot is operating, does not have permission to do so. This prevents any inadvertent or malicious acts from a bot under which bot 804 executes.

The control room 808 can provide, to the client device 810, software code to implement a node manager 814. The node manager 814 executes on the client device 810 and provides a user 812 a visual interface via browser 813 to view progress of and to control execution of automation tasks. It should be noted that the node manager 814 can be provided to the client device 810 on demand, when required by the client device 810, to execute a desired automation task. In one embodiment, the node manager 814 may remain on the client device 810 after completion of the requested automation task to avoid the need to download it again. In another embodiment, the node manager 814 may be deleted from the client device 810 after completion of the requested automation task. The node manager 814 can also maintain a connection to the control room 808 to inform the control room 808 that device 810 is available for service by the control room 808, irrespective of whether a live user session 818 exists. When executing a bot 804, the node manager 814 can impersonate the user 812 by employing credentials associated with the user 812.

The control room 808 initiates, on the client device 810, a user session 818 (seen as a specific instantiation 818.1) to perform the automation task. The control room 808 retrieves the set of task processing instructions 804 that correspond to the work item 806. The task processing instructions 804 that correspond to the work item 806 can execute under control of the user session 818.1, on the client device 810. The node manager 814 can provide update data indicative of status of processing of the work item to the control room 808. The control room 808 can terminate the user session 818.1 upon completion of processing of the work item 806. The user session 818.1 is shown in further detail at 819, where an instance 824.1 of user session manager 824 is seen along with a bot player 826, proxy service 828, and one or more virtual machine(s) 830, such as a virtual machine that runs Java® or Python®. The user session manager 824 provides a generic user session context within which a bot 804 executes.

The bots 804 execute on a player, via a computing device, to perform the functions encoded by the bot. Some or all of the bots 804 may in certain embodiments be located remotely from the control room 808. Moreover, the devices 810 and 811, which may be conventional computing devices, such as for example, personal computers, server computers, laptops, tablets and other portable computing devices, may also be located remotely from the control room 808. The devices 810 and 811 may also take the form of virtual computing devices. The bots 804 and the work items 806 are shown in separate containers for purposes of illustration but they may be stored in separate or the same device(s), or across multiple devices. The control room 808 can perform user management functions, source control of the bots 804, along with providing a dashboard that provides analytics and results of the bots 804, performs license management of software required by the bots 804 and manages overall execution and management of scripts, clients, roles, credentials, security, etc. The major functions performed by the control room 808 can include: (i) a dashboard that provides a summary of registered/active users, tasks status, repository details, number of clients connected, number of scripts passed or failed recently, tasks that are scheduled to be executed and those that are in progress; (ii) user/role management—permits creation of different roles, such as bot creator, bot runner, admin, and custom roles, and activation, deactivation and modification of roles; (iii) repository management—to manage all scripts, tasks, workflows and reports etc; (iv) operations management—permits checking status of tasks in progress and history of all tasks, and permits the administrator to stop/start execution of bots currently executing; (v) audit trail—logs creation of all actions performed in the control room; (vi) task scheduler—permits scheduling tasks which need to be executed on different clients at any particular time; (vii) credential management—permits password management; and (viii) security: management—permits rights management for all user roles. The control room 808 is shown generally for simplicity of explanation. Multiple instances of the control room 808 may be employed where large numbers of bots are deployed to provide for scalability of the RPA system 800.

In the event that a device, such as device 811 (e.g., operated by user 812.2) does not satisfy the minimum processing capability to run a node manager 814, the control room 808 can make use of another device, such as device 815, that has the requisite capability. In such case, a node manager 814 within a Virtual Machine (VM), seen as VM 816, can be resident on the device 815. The node manager 814 operating on the device 815 can communicate with browser 813 on device 811. This approach permits RPA system 800 to operate with devices that may have lower processing capability, such as older laptops, desktops, and portable/mobile devices such as tablets and mobile phones. In certain embodiments the browser 813 may take the form of a mobile application stored on the device 811. The control room 808 can establish a user session 818.2 for the user 812.2 while interacting with the control room 808 and the corresponding user session 818.2 operates as described above for user session 818.1 with user session manager 824 operating on device 810 as discussed above.

In certain embodiments, the user session manager 824 provides five functions. First is a health service 838 that maintains and provides a detailed logging of bot execution including monitoring memory and CPU usage by the bot and other parameters such as number of file handles employed. The bots 804 can employ the health service 838 as a resource to pass logging information to the control room 808. Execution of the bot is separately monitored by the user session manager 824 to track memory, CPU, and other system information. The second function provided by the user session manager 824 is a message queue 840 for exchange of data between bots executed within the same user session 818. The third function is a deployment service (also referred to as a deployment module) 842 that connects to the control room 808 to request execution of a requested bot 804. The deployment service 842 can also ensure that the environment is ready for bot execution, such as by making available dependent libraries. The fourth function is a bot launcher 844 which can read metadata associated with a requested bot 804 and launch an appropriate container and begin execution of the requested bot. The fifth function is a debugger service 846 that can be used to debug bot code.

The bot player 826 can execute, or play back, a sequence of instructions encoded in a bot. The sequence of instructions can, for example, be captured by way of a recorder when a human performs those actions, or alternatively the instructions are explicitly coded into the bot. These instructions enable the bot player 826, to perform the same actions as a human would do in their absence. In one implementation, the instructions can compose of a command (action) followed by set of parameters, for example: Open Browser is a command, and a URL would be the parameter for it to launch a web resource. Proxy service 828 can enable integration of external software or applications with the bot to provide specialized services. For example, an externally hosted artificial intelligence system could enable the bot to understand the meaning of a “sentence.”

The user 812.1 can interact with node manager 814 via a conventional browser 813 which employs the node manager 814 to communicate with the control room 808. When the user 812.1 logs in from the client device 810 to the control room 808 for the first time, the user 812.1 can be prompted to download and install the node manager 814 on the device 810, if one is not already present. The node manager 814 can establish a web socket connection to the user session manager 824, deployed by the control room 808 that lets the user 812.1 subsequently create, edit, and deploy the bots 804.

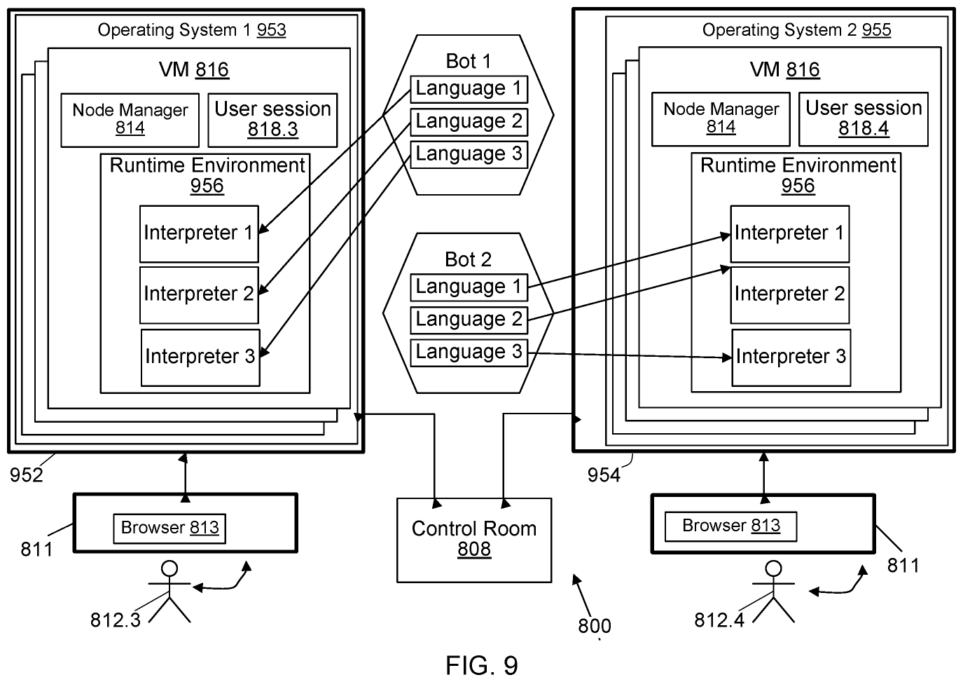

FIG. 9 is a block diagram of a generalized runtime environment for bots 804 in accordance with another embodiment of the RPA system 800 illustrated in FIG. 8. This flexible runtime environment advantageously permits extensibility of the platform to enable use of various languages in encoding bots. In the embodiment of FIG. 9, RPA system 800 generally operates in the manner described in connection with FIG. 8, except that in the embodiment of FIG. 9, some or all of the user sessions 818 execute within a virtual machine 816. This permits the bots 804 to operate on an RPA system 800 that runs on an operating system different from an operating system on which a bot 804 may have been developed. For example, if a bot 804 is developed on the Windows® operating system, the platform agnostic embodiment shown in FIG. 9 permits the bot 804 to be executed on a device 952 or 954 executing an operating system 953 or 955 different than Windows®, such as, for example, Linux. In one embodiment, the VM 816 takes the form of a Java Virtual Machine (JVM) as provided by Oracle Corporation. As will be understood by those skilled in the art in view of the present disclosure, a JVM enables a computer to run Java® programs as well as programs written in other languages that are also compiled to Java® bytecode.

In the embodiment shown in FIG. 9, multiple devices 952 can execute operating system 1, 953, which may, for example, be a Windows® operating system. Multiple devices 954 can execute operating system 2, 955, which may, for example, be a Linux® operating system. For simplicity of explanation, two different operating systems are shown, by way of example and additional operating systems such as the macOS®, or other operating systems may also be employed on devices 952, 954 or other devices. Each device 952, 954 has installed therein one or more VM's 816, each of which can execute its own operating system (not shown), which may be the same or different than the host operating system 953/955. Each VM 816 has installed, either in advance, or on demand from control room 808, a node manager 814. The embodiment illustrated in FIG. 9 differs from the embodiment shown in FIG. 8 in that the devices 952 and 954 have installed thereon one or more VMs 816 as described above, with each VM 816 having an operating system installed that may or may not be compatible with an operating system required by an automation task. Moreover, each VM has installed thereon a runtime environment 956, each of which has installed thereon one or more interpreters (shown as interpreter 1, interpreter 2, interpreter 3). Three interpreters are shown by way of example but any run time environment 956 may, at any given time, have installed thereupon less than or more than three different interpreters. Each interpreter 956 is specifically encoded to interpret instructions encoded in a particular programming language. For example, interpreter 1 may be encoded to interpret software programs encoded in the Java® programming language, seen in FIG. 9 as language 1 in Bot 1 and Bot 2. Interpreter 2 may be encoded to interpret software programs encoded in the Python® programming language, seen in FIG. 9 as language 2 in Bot 1 and Bot 2, and interpreter 3 may be encoded to interpret software programs encoded in the R programming language, seen in FIG. 9 as language 3 in Bot 1 and Bot 2.

Turning to the bots Bot 1 and Bot 2, each bot may contain instructions encoded in one or more programming languages. In the example shown in FIG. 9, each bot can contain instructions in three different programming languages, for example, Java®, Python® and R. This is for purposes of explanation and the embodiment of FIG. 9 may be able to create and execute bots encoded in more or less than three programming languages. The VMs 816 and the runtime environments 956 permit execution of bots encoded in multiple languages, thereby permitting greater flexibility in encoding bots. Moreover, the VMs 816 permit greater flexibility in bot execution. For example, a bot that is encoded with commands that are specific to an operating system, for example, open a file, or that requires an application that runs on a particular operating system, for example, Excel® on Windows®, can be deployed with much greater flexibility. In such a situation, the control room 808 will select a device with a VM 816 that has the Windows® operating system and the Excel® application installed thereon. Licensing fees can also be reduced by serially using a particular device with the required licensed operating system and application(s), instead of having multiple devices with such an operating system and applications, which may be unused for large periods of time.

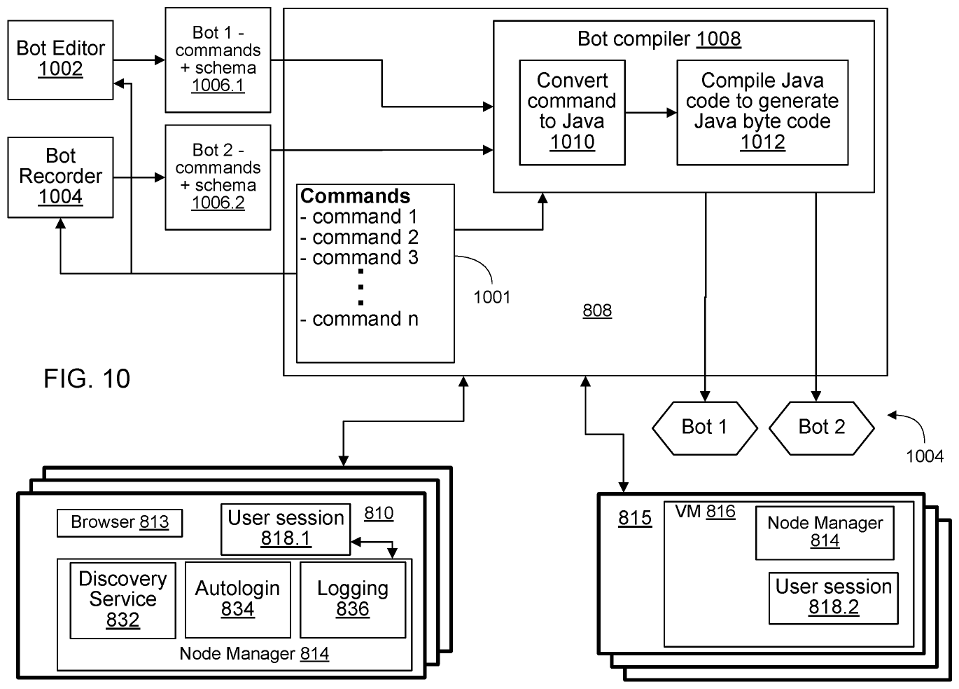

FIG. 10 illustrates a block diagram of yet another embodiment of the RPA system 800 of FIG. 8 configured to provide platform independent sets of task processing instructions for bots 804. Two bots 804, bot 1 and bot 2 are shown in FIG. 10. Each of bots 1 and 2 are formed from one or more commands 1001, each of which specifies a user level operation with a specified application program, or a user level operation provided by an operating system. Sets of commands 1006.1 and 1006.2 may be generated by bot editor 1002 and bot recorder 1004, respectively, to define sequences of application-level operations that are normally performed by a human user. The bot editor 1002 may be configured to combine sequences of commands 1001 via an editor. The bot recorder 1004 may be configured to record application-level operations performed by a user and to convert the operations performed by the user to commands 1001. The sets of commands 1006.1 and 1006.2 generated by the editor 1002 and the recorder 1004 can include command(s) and schema for the command(s), where the schema defines the format of the command(s). The format of a command can, such as, includes the input(s) expected by the command and their format. For example, a command to open a URL might include the URL, a user login, and a password to login to an application resident at the designated URL.

The control room 808 operates to compile, via compiler 1008, the sets of commands generated by the editor 1002 or the recorder 1004 into platform independent executables, each of which is also referred to herein as a bot JAR (Java ARchive) that perform application-level operations captured by the bot editor 1002 and the bot recorder 1004. In the embodiment illustrated in FIG. 10, the set of commands 1006, representing a bot file, can be captured in a JSON (JavaScript Object Notation) format which is a lightweight data-interchange text-based format. JSON is based on a subset of the JavaScript Programming Language Standard ECMA-262 3rd Edition—December 1999. JSON is built on two structures: (i) a collection of name/value pairs; in various languages, this is realized as an object, record, struct, dictionary, hash table, keyed list, or associative array, (ii) an ordered list of values which, in most languages, is realized as an array, vector, list, or sequence. Bots 1 and 2 may be executed on devices 810 and/or 815 to perform the encoded application-level operations that are normally performed by a human user.

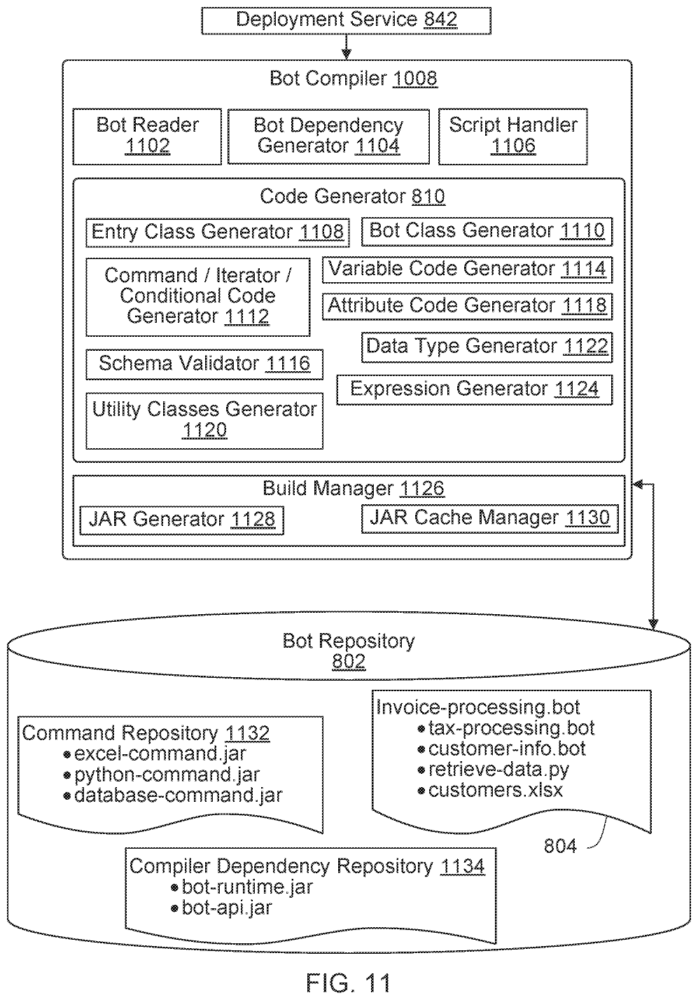

FIG. 11 is a block diagram illustrating details of one embodiment of the bot compiler 1008 illustrated in FIG. 10. The bot compiler 1008 accesses one or more of the bots 804 from the data storage 802, which can serve as bot repository, along with commands 1001 that are contained in a command repository 1132. The bot compiler 808 can also access compiler dependency repository 1134. The bot compiler 808 can operate to convert each command 1001 via code generator module 1010 to an operating system independent format, such as a Java command. The bot compiler 808 then compiles each operating system independent format command into byte code, such as Java byte code, to create a bot JAR. The convert command to Java module 1010 is shown in further detail in in FIG. 11 by JAR generator 1128 of a build manager 1126. The compiling to generate Java byte code module 1012 can be provided by the JAR generator 1128. In one embodiment, a conventional Java compiler, such as javac from Oracle Corporation, may be employed to generate the bot JAR (artifacts). As will be appreciated by those skilled in the art, an artifact in a Java environment includes compiled code along with other dependencies and resources required by the compiled code. Such dependencies can include libraries specified in the code and other artifacts. Resources can include web pages, images, descriptor files, other files, directories and archives.

As noted in connection with FIG. 10, deployment service 842 can be responsible to trigger the process of bot compilation and then once a bot has compiled successfully, to execute the resulting bot JAR on selected devices 810 and/or 815. The bot compiler 1008 can comprises a number of functional modules that, when combined, generate a bot 804 in a JAR format. A bot reader 1102 loads a bot file into memory with class representation. The bot reader 1102 takes as input a bot file and generates an in-memory bot structure. A bot dependency generator 1104 identifies and creates a dependency graph for a given bot. It includes any child bot, resource file like script, and document or image used while creating a bot. The bot dependency generator 1104 takes, as input, the output of the bot reader 1102 and provides, as output, a list of direct and transitive bot dependencies. A script handler 1106 handles script execution by injecting a contract into a user script file. The script handler 1106 registers an external script in manifest and bundles the script as a resource in an output JAR. The script handler 1106 takes, as input, the output of the bot reader 1102 and provides, as output, a list of function pointers to execute different types of identified scripts like Python, Java, VB scripts.

An entry class generator 1108 can create a Java class with an entry method, to permit bot execution to be started from that point. For example, the entry class generator 1108 takes, as an input, a parent bot name, such “Invoice-processing.bot” and generates a Java class having a contract method with a predefined signature. A bot class generator 1110 can generate a bot class and orders command code in sequence of execution. The bot class generator 1110 can take, as input, an in-memory bot structure and generates, as output, a Java class in a predefined structure. A Command/Iterator/Conditional Code Generator 1112 wires up a command class with singleton object creation, manages nested command linking, iterator (loop) generation, and conditional (If/Else If/Else) construct generation. The Command/Iterator/Conditional Code Generator 1112 can take, as input, an in-memory bot structure in JSON format and generates Java code within the bot class. A variable code generator 1114 generates code for user defined variables in the bot, maps bot level data types to Java language compatible types, and assigns initial values provided by user. The variable code generator 1114 takes, as input, an in-memory bot structure and generates Java code within the bot class. A schema validator 1116 can validate user inputs based on command schema and includes syntax and semantic checks on user provided values. The schema validator 1116 can take, as input, an in-memory bot structure and generates validation errors that it detects. The attribute code generator 1118 can generate attribute code, handles the nested nature of attributes, and transforms bot value types to Java language compatible types. The attribute code generator 1118 takes, as input, an in-memory bot structure and generates Java code within the bot class. A utility classes generator 1120 can generate utility classes which are used by an entry class or bot class methods. The utility classes generator 1120 can generate, as output, Java classes. A data type generator 1122 can generate value types useful at runtime. The data type generator 1122 can generate, as output, Java classes. An expression generator 1124 can evaluate user inputs and generates compatible Java code, identifies complex variable mixed user inputs, inject variable values, and transform mathematical expressions. The expression generator 1124 can take, as input, user defined values and generates, as output, Java compatible expressions.

The JAR generator 1128 can compile Java source files, produces byte code and packs everything in a single JAR, including other child bots and file dependencies. The JAR generator 1128 can take, as input, generated Java files, resource files used during the bot creation, bot compiler dependencies, and command packages, and then can generate a JAR artifact as an output. The JAR cache manager 1130 can put a bot JAR in cache repository so that recompilation can be avoided if the bot has not been modified since the last cache entry. The JAR cache manager 1130 can take, as input, a bot JAR.

In one or more embodiment described herein command action logic can be implemented by commands 1001 available at the control room 808. This permits the execution environment on a device 810 and/or 815, such as exists in a user session 818, to be agnostic to changes in the command action logic implemented by a bot 804. In other words, the manner in which a command implemented by a bot 804 operates need not be visible to the execution environment in which a bot 804 operates. The execution environment is able to be independent of the command action logic of any commands implemented by bots 804. The result is that changes in any commands 1001 supported by the RPA system 800, or addition of new commands 1001 to the RPA system 800, do not require an update of the execution environment on devices 810, 815. This avoids what can be a time and resource intensive process in which addition of a new command 1001 or change to any command 1001 requires an update to the execution environment to each device 810, 815 employed in an RPA system. Take, for example, a bot that employs a command 1001 that logs into an on-online service. The command 1001 upon execution takes a Uniform Resource Locator (URL), opens (or selects) a browser, retrieves credentials corresponding to a user on behalf of whom the bot is logging in as, and enters the user credentials (e.g., username and password) as specified. If the command 1001 is changed, for example, to perform two-factor authentication, then it will require an additional resource (the second factor for authentication) and will perform additional actions beyond those performed by the original command (for example, logging into an email account to retrieve the second factor and entering the second factor). The command action logic will have changed as the bot is required to perform the additional changes. Any bot(s) that employ the changed command will need to be recompiled to generate a new bot JAR for each changed bot and the new bot JAR will need to be provided to a bot runner upon request by the bot runner. The execution environment on the device that is requesting the updated bot will not need to be updated as the command action logic of the changed command is reflected in the new bot JAR containing the byte code to be executed by the execution environment.

The embodiments herein can be implemented in the general context of computer-executable instructions, such as those included in program modules, being executed in a computing system on a target, real or virtual, processor. Generally, program modules include routines, programs, libraries, objects, classes, components, data structures, etc. that perform particular tasks or implement particular abstract data types. The program modules may be obtained from another computer system, such as via the Internet, by downloading the program modules from the other computer system for execution on one or more different computer systems. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may further include a device or product having content stored thereon at a time of sale or delivery. Thus, delivering a device with stored content, or offering content for download over a communication medium, may be understood as providing an article of manufacture with such content described herein.

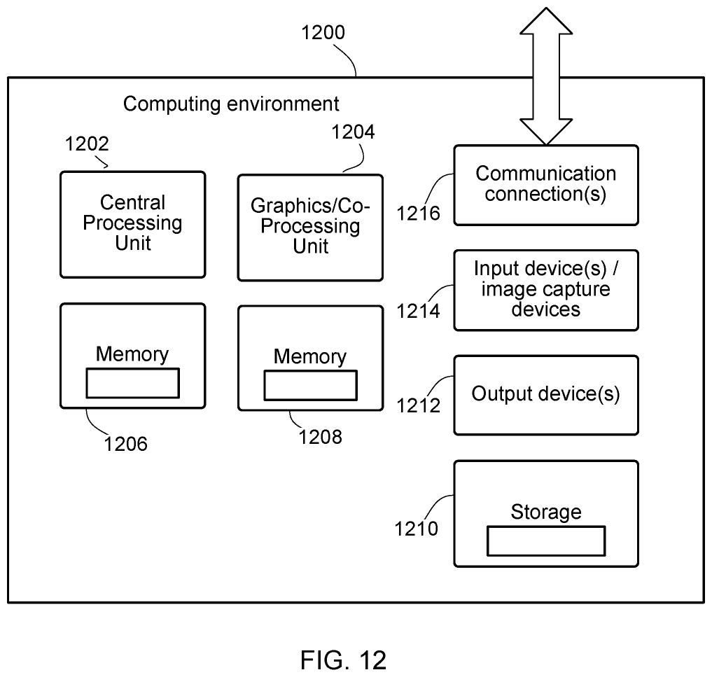

FIG. 12 illustrates a block diagram of an exemplary computing environment 1200 for an implementation of an RPA system, such as the RPA systems disclosed herein. The embodiments described herein may be implemented using the exemplary computing environment 1200. The exemplary computing environment 1200 includes one or more processing units 1202, 1204 and memory 1206, 1208. The processing units 1202, 1206 execute computer-executable instructions. Each of the processing units 1202, 1206 can be a general-purpose central processing unit (CPU), processor in an application-specific integrated circuit (ASIC) or any other type of processor. For example, as shown in FIG. 12, the processing unit 1202 can be a CPU, and the processing unit can be a graphics/co-processing unit (GPU). The tangible memory 1206, 1208 may be volatile memory (e.g., registers, cache, RAM), non-volatile memory (e.g., ROM, EEPROM, flash memory, etc.), or some combination of the two, accessible by the processing unit(s). The hardware components may be standard hardware components, or alternatively, some embodiments may employ specialized hardware components to further increase the operating efficiency and speed with which the RPA system operates. The various components of exemplary computing environment 1200 may be rearranged in various embodiments, and some embodiments may not require nor include all of the above components, while other embodiments may include additional components, such as specialized processors and additional memory.

The exemplary computing environment 1200 may have additional features such as, for example, tangible storage 1210, one or more input devices 1214, one or more output devices 1212, and one or more communication connections 1216. An interconnection mechanism (not shown) such as a bus, controller, or network can interconnect the various components of the exemplary computing environment 1200. Typically, operating system software (not shown) provides an operating system for other software executing in the exemplary computing environment 1200, and coordinates activities of the various components of the exemplary computing environment 1200.

The tangible storage 1210 may be removable or non-removable, and includes magnetic disks, magnetic tapes or cassettes, CD-ROMs, DVDs, or any other medium which can be used to store information in a non-transitory way, and which can be accessed within the computing system 1200. The tangible storage 1210 can store instructions for the software implementing one or more features of a PRA system as described herein.

The input device(s) or image capture device(s) 1214 may include, for example, one or more of a touch input device (such as a keyboard, mouse, pen, or trackball), a voice input device, a scanning device, an imaging sensor, touch surface, or any other device capable of providing input to the exemplary computing environment 1200. For multimedia embodiment, the input device(s) 1214 can, for example, include a camera, a video card, a TV tuner card, or similar device that accepts video input in analog or digital form, a microphone, an audio card, or a CD-ROM or CD-RW that reads audio/video samples into the exemplary computing environment 1200. The output device(s) 1212 can, for example, include a display, a printer, a speaker, a CD-writer, or any another device that provides output from the exemplary computing environment 1200.

The one or more communication connections 1216 can enable communication over a communication medium to another computing entity. The communication medium conveys information such as computer-executable instructions, audio or video input or output, or other data. The communication medium can include a wireless medium, a wired medium, or a combination thereof.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. In one embodiment, the computer readable medium is non-transitory. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for identifying user-initiated processes, the method comprising:
acquiring recordings of at least one user interacting with at least one application program operating on at least one user computing device, the recordings including at least user-initiated events, and a user interface (UI) screen image captured for each of the user-initiated events;
acquiring UI controls and metadata from the captured UI screen images;
identifying, from the acquired UI controls, a set of selected UI controls that a user selected during the recordings;
obtaining, from the set of selected UI controls, a subset of UI controls that are ranked with respect to each UI control's likelihood of being selected by a user to start or stop a user-initiated process; and
selecting a set of UI screen images from the captured UI screen images, based on the subset of UI controls that are known to indicate a start or stop of user-initiated processes, that are candidate UI screen images for corresponding to a start or a stop of a user-initiated process.

2. A computer-implemented method as recited in claim 1, wherein the identifying, the obtaining, and the selecting are performed on at least one server computer, and wherein the at least one server computer operable to couple to at least one network to acquire the recordings from the at least one user computer device, the at least one server computer being remote from the at least one user computer device.

3. A computer-implemented method as recited in claim 1, wherein each of the candidate UI screen images include at least one of the UI controls within the subset of UI controls that are known to indicate a start or stop of repeatable user-driven processes.

4. A computer-implemented method as recited in claim 1, wherein the selecting each of the set of the candidate UI screen images is based on a frequency-based selection scheme, with those of the candidate UI screen images that occur more frequently in the captured UI screen images being more likely selected.

5. A computer-implemented method as recited in claim 1, wherein the selecting the set of the candidate UI screen images comprises:
ranking the captured UI screen images based on the subset of UI controls that are ranked with respect to each UI control's likelihood of being selected by a user to start or stop a user-initiated processes; and
selecting the set of candidate UI screen images from the ranked UI screen images.

6. A computer-implemented method as recited in claim 5, wherein the ranking of the UI screen images uses at least a heuristic ranking.

7. A computer-implemented method as recited in claim 1, wherein the method comprises:
identifying a particular repeatable user-driven process based on the set of candidate UI screen images; and
converting the particular repeatable user-driven process into a software robot.

8. A computer-implemented method as recited in claim 7, wherein the particular repeatable user-driven process is a business process associated with a user.

9. A computer-implemented method as recited in claim 1, wherein the obtaining of the set of UI controls that are known to indicate a start or stop of repeatable user-driven processes comprises:
obtaining a set of start UI controls that are known to indicate a start of repeatable user-driven processes; and
obtaining a set of stop UI controls that are known to indicate a stop of repeatable user-driven processes.

10. A computer-implemented method as recited in claim 9, wherein the selecting the set of the candidate UI screen images comprises:
selecting a set of candidate start UI screen images from the captured UI screen images based on the set of start UI controls; and
selecting a set of candidate stop UI screen images from the captured UI screen images based on the set of stop UI controls.

11. A computer-implemented method as recited in claim 10, wherein the selecting each of the set of the candidate start and stop UI screen images is based on a frequency-based selection, with those of the candidate start and stop UI screen images that occur more frequently in the captured UI screen images being more likely selected.

12. A computer-implemented method as recited in claim 10, wherein the selecting each of the set of candidate start and stop UI screen images is based on a frequency-based selection, with those of the candidate start and stop UI screen images in which a user selects a start or stop UI control, respectively, more frequently being more likely selected.

13. A computer-implemented method as recited in claim 10, wherein the selecting the set of the candidate UI screen images comprises:
ranking the candidate start and stop UI screen images, respectively, based on the subset of UI controls that are known to indicate a start or stop of repeatable user-driven processes; and
selecting the set of candidate start and stop UI screen images from the ranked, start and stop candidate UI screen images, respectively.

14. A computer-implemented method as recited in claim 13, wherein the ranking of the UI screen images uses at least a heuristic ranking.

15. A computer-implemented method as recited in claim 13, wherein the method comprises:
identifying a particular repeatable user-driven process based on the set of candidate start and stop UI screen images; and
converting the particular repeatable user-driven process into a software robot.

16. A computer-implemented method as recited in claim 15, wherein the particular repeatable user-driven process is a business process associated with a user.

17. A computer-implemented method for locating repeatable user-driven processes for conversion into software robots, the method comprising:
acquiring recordings of a plurality of users interacting with at least application programs operating on user computing devices, the recordings including at least user-triggered events with corresponding user interface (UI) screen images captured for the user-triggered events;
acquiring UI controls and metadata from the UI screen images within the recordings;
identifying, from the acquired UI controls, a set of selected UI controls that a user selected during the recordings;
obtaining a set of UI controls that are known to indicate a start or stop of repeatable user-driven processes; and
selecting a set of candidate UI screen images from the UI screen images within the recordings based on those of the set of selected UI controls that a user selected during the recordings which are within the set of UI controls that are known to indicate a start or stop of repeatable user-driven processes.

18. A computer-implemented method as recited in claim 17, wherein the selecting of the set of candidate UI screen images is based at least in part on the frequency in which the UI screen images having the set of UI controls that are known to indicate a start or stop of repeatable user-driven processes occur within the recordings.

19. A computer-implemented method as recited in claim 17, wherein the obtaining a set of UI controls that are known to indicate a start or stop of repeatable user-driven processes comprises determining at least a part of the set of UI controls that are known to indicate a start or stop of repeatable user-driven processes by use of machine learning.

20. A computer-implemented method as recited in claim 17, wherein the selecting of the set of candidate UI screen images includes at least ranking the candidate UI screen images.

21. A computer-implemented method as recited in claim 20, wherein the ranking uses at least a heuristic ranking.

22. A computer-implemented method as recited in claim 17, wherein the acquiring the UI controls and metadata comprises:
processing the UI screen images to detect UI controls within the UI screen images; and
Optical Character Recognition (OCR) processing to recognize text within the UI screen images; and
associating text strings from the recognized text to corresponding ones of a plurality of the corresponding UI controls.

23. A computer-implemented method as recited in claim 22, wherein the associating text strings from the recognized text to corresponding ones of a plurality of the corresponding UI controls is based on respective location of the recognized text and the corresponding UI controls on the corresponding UI screen image.

24. A computer-implemented method as recited in claim 22, wherein the text string and the corresponding UI control are at least a portion of the metadata for at least one of the user-triggered events.

25. A computer-implemented method as recited in claim 24, wherein a portion of the metadata is derived from the OCR processing of the UI screen images associated with the user-triggered events.

26. A computer-implemented method as recited in claim 17, wherein the method comprises:
identifying a particular UI control that the user interacted with based on an input location provided by an operating system of the respective user computing device;
determining a control type for the particular UI control; and
determining a text field associated with the particular UI control from a portion of the metadata derived from Optical Character Recognition (OCR) processing of the UI screen images associated with the user-triggered events.

27. A computer-implemented method as recited in claim 17, wherein the acquiring of the recordings of a plurality of users interacting with at least application programs operating on their respective user computing devices acquires a dataset formed over a period of time, the period of time being at least two days in duration.

28. A non-transitory computer readable medium including at least computer program code tangible stored therein for locating repeatable user-driven processes, the computer readable medium comprising:
computer program code for acquiring recordings of a plurality of users interacting with at least application programs operating on their respective user computing devices, the recordings including at least user-triggered events, and a user interface (UI) screen image captured for each of the user-triggered events;
computer program code for acquiring UI controls and metadata from the captured UI screen images;
computer program code for identifying, from the acquired UI controls, a set of selected UI controls that a user selected during the recordings;
computer program code for obtaining, from the set of selected UI controls, a subset of UI controls that are known to indicate a start or stop of repeatable user-driven processes; and
computer program code for selecting a set of candidate UI screen images from the captured UI screen images based on the subset of UI controls that are known to indicate a start or stop of repeatable user-driven processes.

29. A non-transitory computer readable medium as recited in claim 28, wherein each of the candidate UI screen images include at least one of the UI controls within the set of UI controls that are known to indicate a start or stop of repeatable user-driven processes, wherein the at least one of the UI controls within the set of UI controls is also one of the selected UI controls within the set of selected UI controls.
